(19) United States
(12) Patent Application Publication
(10) Pub. No.: US 2021/0171880 A1
(43) Pub. Date: Jun. 10, 2021

(54) FOAMABLE CLEANING COMPOSITION

(71) Applicant: Conopco, Inc., d/b/a UNILEVER, Englewood Cliffs, NJ (US)

(72) Inventors: Koushik ACHARYA, Kolkata (IN); Arpita SARKAR, Bangalore (IN); Narayanan SUBRAHMANIAM, Bangalore (IN)

(73) Assignee: Conopco, Inc., d/b/a UNILEVER, Englewood Cliffs, NJ (US)

(21) Appl. No.: 16/771,735

(22) PCT Filed: Dec. 4, 2018
(86) PCT No.: PCT/EP2018/083532

§ 371 Date: Jun. 11, 2020

(30) Foreign Application Priority Data
Dec. 12, 2017 (EP) 17206621.9

(51) Int. Cl. C11D 11/00; C11D 1/29; C11D 1/72; C11D 1/75; C11D 1/90; C11D 1/83; C11D 3/00; C11D 3/04; C11D 3/39; C11D 17/00

(52) U.S. Cl. CPC C11D 11/0058; C11D 1/29; C11D 1/72; C11D 1/75; C11D 1/90; C11D 1/83; C11D 17/0043; C11D 3/0094; C11D 3/044; C11D 3/391; C11D 11/0017; C11D 17/0008; C11D 3/0047

(57) ABSTRACT

The present invention relates to a pre-treatment composition for the cleaning of fabrics, especially a sprayable foamable liquid cleaning composition. It is an object of the present invention to provide a sprayable foamable liquid cleaning composition for the pretreatment of fabric which has superior soil removal properties for a wide variety of stains. It is yet another object of the present invention to provide a foamable cleaning composition having a pH of less than 4 which provides good stain removal benefits without compromising on the stability of the isotropic solution or foam structure. We have found that a foamable liquid composition providing a stable foam which exhibits dilutability, homogeneity in solution, excellent cleaning performance on various stain types can be prepared when higher levels of solvents and low pH are combined with specific amounts of alkoxylated anionic surfactant, nonionic surfactant, amphoteric surfactant and at specific ratios between the surfactant and solvents.

### FIELD OF THE INVENTION

The present invention relates to a pre-treatment composition for the cleaning of fabrics, especially a sprayable foamable liquid cleaning composition.

### BACKGROUND OF THE INVENTION

Removal of stains from fabric can be a challenge. Washing stained fabric with a detergent may produce a satisfactory result if the stains are light and not greasy.

However, if the stains are heavy, washing with detergent often does not remove the stains because the detergent ingredients are diluted in the wash and are not concentrated at the stain.

To successfully remove heavy stains, it is known in the art to apply a separate stain treatment, e.g., by spraying or squirting a stain treatment product directly on the stain or using a wipe impregnated with a stain treatment product to scrub a stain.

Sprayable cleaning composition have been used for many years for both household and institutional cleaning of a variety of organic and inorganic soils such as food residue, soap scum, grease, hardness components and the like. Commonly these cleaners comprise a major proportion of a solvent such as water or a mixed aqueous-organic solvent. These spray compositions are usually formulated at a near-neutral pH (about 7) or an alkaline pH (up to about 12).

One such light duty liquid detergent composition with high foaming properties is disclosed in U.S. Pat. No. 5,840,676 (Drapier, 1998) which relates to a novel microemulsion having a non-ionic surfactant, a C₈ to C₁₈ ethoxylated alkyl ether sulfate anionic surfactant, sulfonate or sulfonate anionic surfactant and a betaine surfactant and a pH of 5 to 8 which is effective in removing grease soils.

More recently WO 2017/087261 A1 (The Procter & Gamble Company) discloses a cleaning product that has a spray dispenser and a cleaning composition having surfactant system, glycol ether and a cleaning amine to provide improved cleaning.

The surfactant system of the cleaning composition has a combination of anionic surfactant and a co-surfactant selected from betaine, amine oxide and mixtures thereof and the weight ratio of surfactant system and the glycol ether in the cleaning composition is from about 5:1 to about 1:1 and the cleaning composition has a pH of greater than 8.

The prior art cleaning composition perform adequately on many soils, however in certain applications neutral or basic cleaning composition have had the drawback that certain soils, can be very difficult to clean since these soils are less soluble at a basic pH. An acidic cleaning composition is indicated for soil removal in these instances.

WO 2008/127803 A1 (Colgate-Palmolive Company) discloses a cleaning composition having an anionic surfactant, lactic acid, a non-ionic surfactant, hydrogen peroxide and water. There is also provided a composition further having an amphoteric surfactant and a glycol ether solvent. The cleaning composition has a pH of 3 to 4 and is a foamable composition within a bottle having a nozzle and a spray pump dispenser and provides cleaning or removing a mineral deposits, bleachable stain or soil from fabrics. The glycol ether solvent is present in amounts ranging from 1 to 4 wt % of the composition.

When sprayed, such cleaners can also create an acidic mist or fog which can cause eye irritation and damage, and if inhaled can cause nose and throat irritation and coughing. For these reasons, sprayable liquid cleaning composition within acidic pH ranges have not drawn the attention that has been given to the development of sprayable neutral or basic cleaning compositions. However, a substantial need remains for an acidic liquid cleaning composition which can be used to efficiently remove soils including dirt, grease and body oil which are found on fabrics.

Foamable liquid compositions are a preferred form of the pre-treatment composition. Foams provides a visible indication of the parts of the surface to which the cleaner has been applied. More importantly, the foam clings to the surface and prevent run-off, thereby minimising the quantity of surfactant containing product which is required and consequently minimising both cost and the release of surfactants into the environment. These compositions are beneficial and provides for applying the composition at lower dosage, enables targeted applications of the composition on the stained portion of the fabric and requires compact packaging as compared to a liquid composition.

Despite the advantages inherent in foamable acidic cleaning compositions, such as reduction of aerosol dispersion, high cling and visibility, etc., few have been disclosed to date, probably because strong acids thought to be necessary for effective cleansing power both destabilize foam and degrade the surfactants necessary to foam the composition.

Solvents in cleaning compositions provides better removal of the oily fatty stains. Increasing the levels of solvent in the pre-treatment composition may improve the efficiency of pre-treatment composition across several different types of stains. To improve the removal of oily fatty stains it is desired to provide stable isotropic compositions with solvent at higher levels, it is further desired that such compositions are also stable in presence of bleach and are foamable.

In the past, there have been disclosures of cleaning composition with solvent added in a micro emulsion format, however these micro emulsion compositions may have stability issues and their preparation requires complicated processing steps. Moreover, these compositions may include around 1 to 20 wt % of the solvent and addition of solvent at higher levels leads to phase separation.

Considering all the above, there exists a need for compositions forming relatively stable foam on application to a surface. Such foamable compositions must be capable of forming an isotropic composition and provide improved stain removing benefits at lower dosage and across various stain types. While several foamable liquid cleaning composition meeting many of these needs separately have been marketed or suggested in literature a need exists for a foamable detergent composition which has the advantages of an acidic pH and incorporating higher levels of water miscible solvent but which is isotropic and provides stable foam.

Accordingly, it is an object of the present invention to provide a sprayable, foamable liquid cleaning composition for the pre-treatment of fabric which has superior soil removal properties for a wide variety of stains.

Another object of the present invention is to provide a laundry pre-treatment composition containing both water and a water miscible solvent which components form into a clear homogeneous liquid that allows for uniform dosing in manufacturing and dispensing.

It is thus an object of the present invention to provide a foamable cleaning composition which provides stable foam having desirable structure, characteristics and density of less than 0.4 g/ml. Such foams with liquid fraction not more than 40% ensures foam integrity and stability and allows foams to cling properly to the surface and not spread immediately.

It is yet another object of the present invention to provide a foamable cleaning composition having a pH of less than 5 which provides good stain removal benefits without compromising on the stability of the isotropic solution or foam structure and stability.

It is yet another object of the present invention to provide a foamable cleaning composition having higher levels of water miscible solvent without impacting the isotropic nature of the composition and the foam structure.

### SUMMARY OF THE INVENTION

We have found that a foamable liquid composition providing a stable foam which exhibits dilutability, homogeneity in solution, excellent cleaning performance on various stain types and can be prepared when higher levels of solvents and low pH are combined with specific amounts of alkyl alkoxylated anionic surfactant, nonionic surfactant, amphoteric surfactant and at specific ratios between the surfactant and solvents.

Accordingly, in a first aspect the invention provides a foamable, liquid cleaning composition comprising:
i. 1 to 20 wt. % C₈₋₁₈ alkoxylated surfactant having 1 to 30 moles of alkylene oxide;
ii. 2 to 25 wt. % nonionic surfactant;
iii. 0.1 to 3 wt. % amphoteric surfactant;
iv. 3 to 40 wt. % water miscible solvent; and,
v. rest water.
   said cleaning composition having a viscosity of less than 100 mPa·s at 25° C. and 20 s⁻¹, and wherein ratio of the sum of alkoxylated surfactant and nonionic surfactant to the solvent is in a weight ratio of 0.3:1 to 9:1 and wherein the pH of the composition is less than 4.

Similarly according to a second aspect, the invention provides a cleaning system comprising a spraying device and a foamable liquid cleaning composition according to the first aspect, said spraying device comprising a container holding the foamable liquid cleaning composition, a spray head, and a liquid supply arrangement for transferring the foamable liquid detergent composition from the container to the spray head and forming a foam with a density of less than 0.4 g/ml when ejected from the spray device through the spray head.

Likewise, according to a third aspect, present invention provides a method of removing oily fatty stains from fabric, said method comprising the steps of:
i. providing a fabric;
ii. pre-treating the fabric by applying a liquid cleaning composition as defined in any one of the preceding claims as a foam onto the surface of the fabric;
iii. washing the pre-treated fabric; and,
iv. drying the washed fabric.

### DETAILED DESCRIPTION OF THE INVENTION

As used herein, the terms “foamable” refers to a composition that is capable of forming foam and trapping gas bubbles in a liquid.

As used herein, the term “foam” refers to a substance that is made by forming and trapping gas bubbles in a liquid. A foam may be formed by injecting air into a foamable liquid composition and trapping the air and the dispensed foam has a density of less than 0.4 g/mL when ejected from a dispensing device for generating foam from a liquid. In particular, a foam can be formed by dispensing the liquid cleaning compositions described herein from a container (e.g., bottle or pump) such that the composition is mixed with gas bubbles, and the bubbles are trapped in the composition. Conventional devices for generating a foam from a liquid can be employed with the compositions and methods of the present invention.

The term “isotropic” is a single-phase composition that is clear or transparent, assessed in absence of opacifiers, pigments, dyes, and the like. More particularly within aqueous liquid detergent compositions it means there is no discrete separate organic phase dispersed within the main aqueous phase. An isotropic composition is distinguished from water-in-oil emulsions, oil-in-water emulsions including micro-emulsions and lamellar phase compositions.

Accordingly, in a first aspect the invention provides a foamable, liquid cleaning composition comprising:
vi. 1 to 20 wt. % C₈₋₁₈ alkoxylated surfactant having 1 to 30 moles of alkylene oxide;
vii. 2 to 25 wt. % nonionic surfactant;
viii. 0.1 to 3 wt. % amphoteric surfactant;
ix. 3 to 40 wt. % water miscible solvent; and,
x. rest water.
   said cleaning composition having a viscosity of less than 100 mPa·s at 25° C. and 20 s⁻¹, and wherein ratio of the sum of alkoxylated surfactant and nonionic surfactant to the solvent is in a weight ratio of 0.3:1 to 9:1 and wherein the pH of the composition is less than 4.

Similarly according to a second aspect, the invention provides a cleaning system comprising a spraying device and a foamable liquid cleaning composition according to the first aspect, said spraying device comprising a container holding the foamable liquid cleaning composition, a spray head, and a liquid supply arrangement for transferring the foamable liquid detergent composition from the container to the spray head and forming a foam with a density of less than 0.4 g/ml when ejected from the spray device through the spray head.

Likewise, according to a third aspect, present invention provides a method of removing oily fatty stains from fabric, said method comprising the steps of:
v. providing a fabric;
vi. pre-treating the fabric by applying a liquid cleaning composition as defined in any one of the preceding claims as a foam onto the surface of the fabric;
vii. washing the pre-treated fabric; and,
viii. drying the washed fabric.

In a fourth aspect, the invention provides use of the composition according to the first aspect for the removal of oily fatty stains from fabric, said use comprising applying the liquid cleaning composition in the form of a foam onto the surface of the fabric.

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### Foamable Liquid Cleaning Composition

The foamable liquid cleaning composition of the present invention has a viscosity of less than 100 mPa·s at 25° C. and 20 s⁻¹. The viscosity describes a fluid's internal resistance to flow and may be thought of as a measure of fluid friction, simply put, the less viscous the fluid is, the greater its ease of movement (fluidity).

The viscosity of the compositions according to the invention is preferably between 1 to 100 mPa·s (25° C. and 20 s-1), more preferably between 5 to 80 mPa·s, when measured with a Brookfield Viscometer (model No— LVDV). Spindle No 02 and the RPM is less than 10. The foamable liquid cleaning composition of the present invention typically has a viscosity of less than 75 mPa·s, more preferably of less than 50 mPa·s, most preferably less than 40 mPa·s at 25° C. and 20 s-1.

The in-bottle pH of the foamable liquid cleaning composition of the present invention should be maintained at acidic conditions, that is, having a pH of less than 4, preferably the pH is from 2 to 3.5, still preferably 2 to 3.

The foamable liquid cleaning composition preferably forms a foam with a density of less than 0.4 g/ml, more preferably of 0.1 to 0.3 g/ml when ejected from the spray device through the spray head.

The foamable liquid cleaning composition is used to treat stained region of the fabric, prior to the usual laundering and washing process with common detergent compositions, to make the removal of the soil from those areas in the subsequent washing process more effective. Such areas are, for example, collars, cuffs, brims of shirts, underwear, which may be heavily soiled with human sebum, as well as industrial clothing, which may become heavily soiled by external soil-sources, not only fats and oils, but also blood and the like.

Alkoxylated C₈₋₁₈ anionic surfactant

The foamable liquid cleaning composition of the present invention comprises 1 to 20 wt % alkoxylated C₈₋₁₈ anionic surfactant. The alkoxylated anionic surfactant has an alkyl group with carbon chain length C₈₋₁₈ and having 1 to 30 moles of alkylene oxide.

This surfactant may have a normal or branched chain alkyl group containing lower ethoxy groups with two or three carbon atoms. A general formula of such surfactants is RO(C₂H₄O)ₓ, SO₃⁻M⁺ where R is an alkyl chain having from 10 to 22 carbon atoms, saturated or unsaturated, M is a cation which makes the compound water-soluble, especially an alkali metal, ammonium or substituted ammonium cation, and x averages from 1 to 15. Preferably R is an alkyl chain having from 8 to 18 carbon atoms, more preferably 8 to 16 carbon atoms, M is sodium and x averages from 1 to 3, more preferably x is 1. It is particularly preferred that the alkoxylated anionic surfactant is an ethoxylated anionic surfactant which is preferably sodium lauryl ether sulphate (SLES). It is the sodium salt of lauryl ether sulphonic acid in which the predominantly C₁₂ lauryl alkyl group is ethoxylated with an average of 1 to 30 moles of ethylene oxide per mole, more preferably 1 to 15 moles of ethylene oxide per mole, still more preferably 1 to 7 moles of ethylene oxide per mole of SLES.

Other examples of suitable ethoxylated anionic surfactants that could be used in accordance with the present invention are C₁₂ to C₁₅ normal or primary alkyl triethoxy sulphate, sodium salt; n-decyl diethoxy sulphate, sodium salt; C₁₂ primary alkyl diethoxy sulphate, ammonium salt; C₁₂ primary alkyl triethoxy sulfate, sodium salt; C₁₅ primary alkyl tetraethoxy sulfate, sodium salt; mixed C₁₄ to C₁₅ normal primary alkyl mixed tri- and tetraethoxy sulfate, sodium salt; stearyl pentaethoxy sulfate, sodium salt; and mixed C₁₀ to C₁₅ normal primary alkyl triethoxy sulfate, potassium salt

The liquid composition according to the present invention includes 1 wt % to 20 wt % of the alkoxylated anionic surfactant. The amount of alkoxylated anionic surfactant in the liquid composition is preferably at least 1 wt. %, more preferably 1 to 20 wt. % of ethoxylated C₈₋₁₈ alkyl ether sulfate surfactant having 1 to 30 moles of ethylene oxide.

Even more preferably, the liquid cleaning composition contains least 1 wt. %, preferably 2 to 16 wt. % of ethoxylated C₈₋₁₈ alkyl ether sulfate surfactant having 1 to 20 moles of ethylene oxide. According to a particularly preferred embodiment, the foamable cleaning composition contains at least 1 wt. %, preferably 1 to 20 wt. % of ethoxylated C₁₀₋₁₄ alkyl ether sulfate surfactant having 1 to 30 moles of ethylene oxide. Yet more preferably, the composition contains at least 1 wt. %, preferably 2 to 16 wt. % of ethoxylated C₁₀₋₁₄ alkyl ether sulfate surfactant having 1 to 20 moles of ethylene oxide.

Most preferably, the liquid cleaning composition contains at least 1 wt. %, preferably 2 to 10 wt. % of ethoxylated lauryl ether sulfate surfactant having 1 to 10 moles of ethylene oxide.

Preferably the amount of alkoxylated anionic surfactant in the foamable liquid cleaning composition is at least 1 wt %, still preferably at least 2.5 wt %, further preferably at least 3 wt % and most preferably at least 5 wt %, but typically not more than 18 wt %, still preferably not more than 15 wt % and most preferably not more than 10 wt % based on the liquid cleaning composition.

### Non-Ionic Surfactant

The foamable liquid cleaning composition of the present invention comprises 2 wt. % to 25 wt. % non-ionic surfactant. Nonionic surfactants are characterized by the presence of a hydrophobic group and an organic hydrophilic group and are typically produced by condensation of an organic aliphatic or alkyl aromatic hydrophobic compound with ethylene oxide.

Usually, the nonionic surfactants are polyalkoxylated lipophiles wherein the desired hydrophile-lipophile balance (HLB) is obtained from addition of a hydrophilic alkoxy group to a lipophilic moiety. A preferred class of nonionic surfactants is the alkoxylated alkanols in which the alkanol is of 9 to 20 carbon atoms and wherein the number of moles of alkylene oxide (of 2 or 3 carbon atoms) is from 5 to 20. Of such materials, it is preferred to use those wherein the alkanol is a fatty alcohol of 9 to 11 or 12 to 15 carbon atoms and which contain from 5 to 8 or 5 to 9 alkoxy groups per mole. Also preferred are paraffin-based alcohols (e.g. nonionic surfactants from Huntsman or Sassol). Preferably the non-ionic surfactant is selected from an alkoxylated linear alcohol, more preferably an ethoxylated linear alcohol.

Exemplary of such compounds are those in which the alkanol is of 10 to 15 carbon atoms and which contain about 5 to 12 ethylene oxide groups per mole, e.g. Neodol™ family. These are condensation products of a mixture of higher fatty alcohols averaging about 12 to 15 carbon atoms with about 9 moles of ethylene oxide. The higher alcohols are primary alkanols.

Another subclass of alkoxylated surfactants which may be used contain a precise alkyl chain length rather than an alkyl chain distribution of the alkoxylated surfactants. Typically, these are referred to as narrow range alkoxylates. Examples of these include the Neodol™-1 series of surfactants.

Other useful non-ionic surfactants are represented by the commercially well-known class of non-ionic surfactants sold under the trademark Plurafac™ from BASF. The Plurafac™ are the reaction products of a higher linear alcohol and a mixture of ethylene and propylene oxides, containing a mixed chain of ethylene oxide and propylene oxide, terminated by a hydroxyl group. Examples include C₁₃-C₁₅ fatty alcohols condensed with 6 moles ethylene oxide and 3 moles propylene oxide, C₁₃-C₁₅ fatty alcohol condensed with 7 moles propylene oxide and 4 moles ethylene oxide, C₁₃-C₁₅ fatty alcohol condensed with 5 moles propylene oxide and 10 moles ethylene oxide or mixtures of any of the above.

Another group of nonionic surfactants are commercially available as Dobanol™ which is an ethoxylated C₁₂-C₁₅ fatty alcohol with an average of 7 moles ethylene oxide per mole of fatty alcohol.

Preferably the amount of nonionic surfactant in the foamable liquid cleaning composition is at least 2 wt %, still preferably at least 2.5 wt %, further preferably at least 3 wt % and most preferably at least 5 wt %, but typically not more than 20 wt %, still preferably not more than 15 wt % and most preferably not more than 10 wt % based on the liquid foamable cleaning composition.

### Amphoteric Surfactant

The liquid composition of the present invention comprises 0.1 wt % to 3 wt % amphoteric surfactant.

The amphoteric surfactant that is employed in accordance with the present invention may be selected from amine oxide, betaine and combinations thereof. A preferred amine oxide is C₁₂₋₁₆ alkyl dimethyl amine oxide. A preferred betaine is cocamidopropyl betaine.

Preferably the amount of amphoteric surfactant in the foamable liquid cleaning composition is at least 0.2 wt %, still preferably at least 0.3 wt %, further preferably at least 0.5 wt % and most preferably at least 0.8 wt %, but typically not more than 2.5 wt %, still preferably not more than 2.25 wt % and most preferably not more than 2 wt % based on the foamable liquid cleaning composition. More preferably, the cleaning composition contains at least 0.1 wt. %, preferably 0.1 to 3 wt. % of amine oxide.

Although not wishing to be bound by theory, the combination of amphoteric surfactant and the alkoxylated anionic surfactant preferably SLES provides a creamy foam which is stable has the desired density according to the present invention.

According to a particularly preferred embodiment, the foamable liquid cleaning composition contains at least 0.1 wt. %, preferably 0.1 to 3 wt. % of C₁₂ to C₁₆ alkyl dimethyl amine oxide.

In the foamable cleaning composition of the present invention the ratio of the sum of alkoxylated surfactant and nonionic surfactant to the water miscible solvent is in a weight ratio of 0.3:1 to 9:1, preferably from 0.5:1 to 8:1, still preferably from 1:1 to 5:1.

### Water Miscible Solvent

The liquid foamable composition of the present invention comprises a water miscible solvent. The amount of water miscible solvent in the foamable liquid cleaning composition is from 3 to 40 wt %, preferably 15 to 40 wt %.

Preferably the water miscible solvent has a Hansen solubility parameter (^{δ}HSP) that ranges from 14 to 22 MPa^{0.5} (at 25° C.), more preferably 15 to 20 MPa^{0.5} (at 25° C.) and most preferably from 15 to 18.5 MPa^{0.5} (at 25° C.). Hansen solubility parameter is preferably calculated using a software called HSPiP Version3.1 (http://hspip.software.informer.com/3.1/). The input given to the software is in the form of SMILES (Simplified Molecular Input Line Entry Specification) of the structure of proposed solvent.

The water miscible solvent is a glycol ether solvent selected from the group consisting of glycol ethers having Formula I, Formula II and mixtures thereof.

R₁O(R₂O)ₙR₃ Formula I

R₄O(R₅O)ₙR₆ Formula II

wherein:
R₁ is a linear or branched C4, C5 or C6 alkyl or a substituted or unsubstituted phenyl,
R₂ is ethyl or isopropyl,
R₃ is hydrogen or methyl and n is 1, 2 or 3.
R₄ is n-propyl or isopropyl,
R₅ is isopropyl,
R₆ is hydrogen or methyl and n is 1, 2 or 3.

Preferred glycol ether solvents according to Formula I are ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, and mixtures thereof. Most preferred glycol ethers according to Formula I are propyleneglycol n-butyl ether, dipropyleneglycol n-butyl ether, and mixtures thereof.

Preferred glycol ether solvents according to Formula II are propyleneglycol n-propyl ether, dipropyleneglycol n-propyl ether, and mixtures thereof. Most preferred glycol ether solvents are propyleneglycol n-butyl ether, dipropyleneglycol n-butyl ether, and mixtures thereof, especially dipropyleneglycol n-butyl ether.

Suitable glycol ether solvents can be purchased from The Dow Chemical Company, more particularly from the E-series (ethylene glycol based) Glycol Ethers and the P-series (propylene glycol based) Glycol Ethers line-ups. Suitable glycol ether solvents include Butyl Carbitol, Hexyl Carbitol, Butyl Cellosolve, Hexyl Cellosolve, Butoxytriglycol, Dowanol Eph, Dowanol PnP, Dowanol DPnP, Dowanol PnB, Dowanol DPnB, Dowanol TPnB, Dowanol PPh, and mixtures thereof.

Preferably the solvent is a glycol ether solvent with flash point more than 80° C., more preferably more than 100° C., most preferably above 115° C.

According to a particularly preferred embodiment, the cleaning composition contains at least 3 wt. %, preferably 3 to 40 wt. % of glycol ether solvent. Preferably the amount of water miscible solvent in the foamable cleaning composition is at least 4 wt %, still preferably at least 5 wt %, further preferably at least 10 wt % and most preferably at least 12 wt %, but typically not more than 35 wt %, still preferably not more than 30 wt % and most preferably not more than 15 wt % based on the cleaning composition.

### Water

The composition of the present invention is an aqueous composition comprising water. The composition is made up to 100 percent by adding water. The composition preferably comprises at least 12 wt. % water, preferably at least 25 wt %, still preferably at least 60 wt %, more preferably, the cleaning composition contains 30 to 90 wt. %, most preferably 40 to 80 wt. % water.

### Hydrogen Peroxide

The composition of the present invention preferably comprises hydrogen peroxide. Hydrogen peroxide is the simplest peroxide (a compound with an oxygen-oxygen single bond) and finds use as a strong oxidizer, bleaching agent and disinfectant.

Hydrogen peroxide is present in the composition of the present invention in a concentration of 2 to 12%, preferably not more than 10%, more preferably not more than 8%, still more preferably not more than 7% but typically not less than 3%, preferably not less than 4%, more preferably not less than 5% by weight of the composition.

Without wishing to be bound by theory, it is thought that hydrogen peroxide acts as the oxidizing agent in the composition and is primarily responsible for the bleaching action, but the superior removal of other stains is achieved by the synergistic effect of hydrogen peroxide in combination with the water miscible solvent.

### Optional Ingredients

The foamable liquid cleaning composition may suitably contain additional ingredients, such as bleach activator, builder, antimicrobial agents, preservatives, fragrance and colouring.

Besides the alkoxylated ether sulfate surfactant, non-ionic surfactant and the amphoteric surfactant, the present cleaning composition preferably contains not more than a limited amount, e.g. less than 1 wt. % of other surfactants. Even more preferably, the cleaning composition contains less than 0.5 wt. % of such other surfactants. Preferably the cleaning composition contains less than 1 wt % secondary alkanesulfonate, even more preferably less than 0.5 wt % of the secondary alkanesulfonates. Most preferably, the cleaning compositions does not contain any other surfactants besides the alkoxylated ether sulfate surfactant and the amphoteric surfactant.

### Buffers

The composition of the present invention preferably comprises buffer. The preferred buffering agent comprises a weak acid and a base. Preferably the buffering agent comprises a carboxylic acid and a base selected from ammonium or alkali metal hydroxides and/or organic amines can also be used. Ammonium hydroxide and sodium hydroxide are particularly preferred. Preferably, such a system will buffer the product at a pH of less than 5, more preferably 2 to 4.5.

More preferably the buffering agent is a weak acid and its salt, more preferably the acid is a weak organic acid. The presence of carboxylic acid as salts in the formulation rather than as the acid form is believed to lead to a better foam so it is preferred that the pH of the composition should be above the lowest pKₐ of the carboxylic acid present. Citric acid, the preferred carboxylic acid, has pKₐ's of 3.14, 4.77 and 6.39 and consequently pH above 3.14 are preferred. The preferred buffering agents are carboxylic acid in combination with its salts. Suitable examples include but are not limited to citric acid and citrate salt; other organic weak acids and their salts.

### Sequesterants

Weak sequesterants in the form of organic polycarboxylic acids are preferred components of the compositions according to the present invention. The presence of these weak sequesterants improves cleaning performance. It is believed that these components sequester weakly bound calcium ions as well as certain transition metal ions like Fe³⁺ ions which are involved in the attachment of soil to surfaces and thereby facilitate the removal of these soils.

Strong sequesterants can also be present. However, sequesterants such as EDTA are less preferred for environmental reasons, as it has been suggested that such poorly biodegradable sequesterants can solubilise heavy metals from river-bottom deposits. Moreover, EDTA and other strong sequesterants have a tendency to complex with the calcium present in the domestic water and prevent the formation of the defoaming calcium soap.

Preferably, the sequesterant is selected from, citric, adipic, succinic, maleic, glutaric acids, mixtures thereof or salts thereof. Typical levels of sequesterant range from 0.5 to 10% wt, preferably 1 to 4% wt on foamable liquid composition.

Most preferably, the citric acid or salts thereof also performs the role of a sequestrant. Citric acid is a weak sequesterant for calcium, available from renewable resources and is rapidly biodegradable.

Citric acid is particularly preferred as both the sequesterant and a component of the buffering agent, at preferable inclusion levels of 1 to 4 wt. % of the foamable liquid cleaning composition. Suitable examples also include phosphonates and other sequestrants which complex with metal ions or transitional metal ions.

### Cleaning System

According to a second aspect, the invention provides a cleaning system comprising a spraying device and a foamable liquid cleaning composition according to the first aspect, said spraying device comprising a container holding the foamable liquid cleaning composition, a spray head, and a liquid supply arrangement for transferring the foamable liquid detergent composition from the container to the spray head and forming a foam with a density of less than 0.4 g/ml when ejected from the spray device through the spray head.

### Spraying Device

The spraying device of the present invention preferably comprises a container having an internal volume of 100 to 1,500 ml, more preferably of 150 to 1,200 ml, even more preferably 180 to 1000 ml and most preferably of 200 to 800 ml.

The spraying device preferably comprises a positive displacement pump that acts directly on the foamable liquid cleaning composition. The pump draws the liquid cleaning composition up into the liquid supply arrangement and transfers the liquid cleaning composition to the spray head, from which it is discharged in the form of a foam, preferably through a nozzle.

In the spraying device of the present invention, the dispensing of the liquid cleaning composition is preferably powered by a user's efforts, i.e. the liquid cleaning composition is not dispensed under pressure by simply actuating a valve and requires manual triggering. The spraying device employed in accordance with the present invention is preferably selected from a trigger spray foam bottle, a squeeze foam bottle and a foam pump. Most preferably the spraying device is a squeeze foam bottle or a foam pump.

In another preferred embodiment, the spray device is configured to mix the liquid cleaning composition with air before it is dispensed from the spray head.

A suitable foaming device is an on-pressurised foam container such as that described in U.S. Pat. No. 3,709,437.

The composition can be placed into the reservoir of a plastic squeeze bottle which contains a foaming spray head or other foam producing means. Squeezing the container causes the liquid cleaning composition to leave the reservoir and enter an air-mixing or foaming chamber via an internal dip tube. The foam produced in the foaming chamber is often passed through a homogenizing element interposed between the air-mixing chamber and the discharge orifice to homogenise and control the consistency of the discharged foam. Further compression of the foam discharges the foam from a discharge cap as a uniform non-pressurised aerated foam. Alternatively the side walls of the container may be rigid and the dip tube may be fitted with a pump that is actuated by a push button. When composition is drawn by the pump through to the air mixing or foaming chamber, the desired foam is produced.

Other means for producing foams will be apparent to those skilled in the art. Means for producing aerated foams are further described in U.S. Pat. Nos. 4,511,486 and 4,018,364.

### Method of Treating a Fabric

In a third aspect, the present invention relates to a method of removing stains from fabric, said method comprising the steps of:
i. providing a fabric;
ii. pre-treating the fabric by applying a liquid cleaning composition of the present invention dispensed in the form of a foam onto the surface of the fabric;
iii. washing the pre-treated fabric; and
iv. drying the washed fabric.

According to a particularly preferred embodiment, the foamable liquid cleaning composition is selectively applied as a foam onto stained areas of the fabric.

According to another preferred embodiment, the liquid cleaning composition is applied by spraying the liquid cleaning composition onto the fabric, especially using the cleaning system described herein.

Preferably the step of washing the pre-treated fabric is carried out in an aqueous solution of a detergent composition having 2 to 80 wt % surfactant.

### Use of the Foamable Liquid Cleaning Composition

In a fourth aspect, the invention relates to the use of the foamable liquid cleaning composition of the present invention for the removal of stains from fabric, said use comprising applying the foamable liquid cleaning composition in the form of a foam onto the surface of the fabric.

Preferably, the foamable liquid cleaning composition is applied in the form of a foam onto the surface of the fabric by means of spraying, more preferably by spraying the liquid cleaning composition using a cleaning system as defined herein.

The invention is further illustrated by means of the following non-limiting examples.

### EXAMPLES

### Materials

Alkoxylated anionic surfactant=SLES paste (70%): Sodium lauryl ether sulphate (LES 70 2EO) procured from Galaxy
Amphoteric surfactant=Cocoamidopropyl betaine (CAPB, 30% solution) procured from Galaxy
Non-ionic surfactant=Ethoxylated fatty alcohol-C₁₂EO₇ (100%) procured from Galaxy
Water miscible solvent=Di(propyleneglycol)dimethyl ether
Sequestrant=Dequest 2010 (1-Hydroxyl ethylidene-1,1-diphosphonic acid, HEDP, 59% solution): Procured from Thermphos, Switzerland
Citric acid (used as is) procured from Merck India
Sodium citrate dihydrate
Deionized water
   Control: Vanish® stain remover spray (Market sample, Imported from Brazil)

### Process for Preparing Compositions

Each of the ingredients was added in the indicated amounts in a plastic container and was mixed using the conditions given bellow:
Mixer type: Overhead stirrer (Heidolph)
RPM: 200-500 rpm
Mixer blade type: Two Flat blades at 90 degree attached to a SS rod which was fitted to the motor.
Mixing time: 30 min for a 1 kg batch size.
Temperature: 25° C. (Lab temperature)

### Product Format

The compositions were packed in Trigger foam sprayer obtained from Guala Dispensing, Italy.

### Process for Pre-Treating a Fabric

The stain monitor used for carrying out the study was a standard single stain monitors procured from SUV-TUV South East Asia Pvt Limited.

For all the compositions, approximately 0.4 ml of the composition was dispensed as a foam and applied on each stain with the help of the above-mentioned foam device. After 5 minutes of application of the liquid, the pre-treated fabrics were washed with Surf Excel matic powder (Top load) in top-loading washing machine (Samsung).

For control the stains on the standard single stain monitor were pre-treated with approximately 1.4 mL of the Vanish stain remover (Market sample) spray, followed by washing with Surf Excel matic powder (Top load) in top-loading washing machine (Samsung).

### Washing Protocol

The pre-treated standard stain monitors were washed in a tergo-to-meter. Liquor volume was maintained at 500 ml and L/C at 50. Washing was done with Brazil OMO powder (ex. Hindustan Unilever Ltd, India) at 1.6 g/L dosage at 6FH. A typical wash cycle comprised of soak, wash and two rinses. After washing was completed, the swatches were removed and then line-dried overnight.

### Evaluation

SRI (stain removal index): SRI was used to evaluate the efficacy of each composition. SRI was measured for each stain using ArtixScan F1 (Innotech Scanner). The SRI values are calculated from the L, a, b values of blank and stained fabrics as follows:

For Blank (unstained) fabrics: L_{B}, a_{B}, b_{B}

For stained fabrics: L_{S}, a_{S}, b_{S}

Delta E=\sqrt{(L_{S}−L_{B})²+(a_{S}−a_{B})²+(b_{S}−b_{B})²}

SRI=100−Delta E

Delta SRI=SRI (Expt)−SRI (Control)

Viscosity Measurement: Viscosity of the foamable liquid composition was measured using Brookfield Viscometer (model No— LVDV). Spindle No. 02 was used for all the measurement. Around 200 ml of the foamable liquid composition was taken in a 250 ml beaker. The spindle was attached to the viscometer head, and it was dipped into the liquid till the mark. The motor was switched on and the RPM of the spindle was set at 10. The viscosity was noted down from the display. To check whether the viscosity value changes with RPM, RPM was increased to 20 and 50 and the viscosity values were noted. Values with torque more than 20% were noted.

pH Measurement: pH of the foamable liquid was measured with a standard pH meter. The pH meter was calibrated for 2 point, pH 4 and pH 7. At first, the probe was washed in demineralized water and then it was calibrated first with pH 4 buffer solution and then with pH7 buffer solution. Once it is calibrated then it was dipped into the test solution. Wait for some time to get a steady reading. The value was noted.

### Example 1: Effect of Anionic Surfactant

Liquid cleaning compositions were prepared on the basis of the recipes shown in Table 1. Composition 1 to 3 are examples of composition according to the present invention, which are compared with comparative compositions A and B which are not according to the invention. The viscosities of the compositions were determined. In addition, the compositions were sprayed from the spray bottle and the density and quality of the foamed composition were determined. In addition, the compositions were sprayed onto the stained fabric and the pre-treated fabric was washed after this treatment following the procedure described herein before. The results are summarized in Table 1.

TABLE 1
Effect of alkoxylated anionic surfactant

| | Marketed | | | | | |
|---|---|---|---|---|---|---|
| | sample | | | | Comp | Comp |
| Ingredient | (Control) | Ex-1 | Ex-2 | Ex-3 | A | B |
| SLES | | 1 | 4 | 15 | 0.5 | 22 |
| C₁₂EO₇ | | 7.5 | 7.5 | 7.5 | 7.5 | 7.5 |
| CAPB | | 0.9 | 0.9 | 0.9 | 0.9 | 0.9 |
| Di(propyleneglycol) | | 6 | 6 | 6 | 6 | 6 |
| dimethyl | | | | | | |
| ether | | | | | | |
| Dequest 2010 | | 1 | 1 | 1 | 1 | 1 |
| Citric acid | | 0.12 | 0.12 | 0.12 | 0.12 | 0.12 |
| Na-citrate | | 0.38 | 0.38 | 0.38 | 0.38 | 0.38 |
| Water | | Rest to | Rest to | Rest to | Rest to | Rest to |
| | | 100 | 100 | 100 | 100 | 100 |
| Viscosity | | 14 | 16 | 35 | 14 | 288 |
| Foam Density | | <0.4 | <0.4 | <0.4 | <0.4 | NA |
| Foamability | | Yes | Yes | Yes | Yes | NA |
| pH | | 3.2-3.5 | 3.2-3.5 | 3.2-3.5 | 3.2-3.5 | 3.2-3.5 |
| Cleaning of of | 86 ± 0.2 | 89.99 ± 0.82 | 92.68 ± 0.37 | 93.24 ± 0.24 | 83.2 ± 0.21 | NA |
| cooking oil (SRI | | | | | | |
| values) | | | | | | |
| Cleaning of | 86.7 ± 0.31 | 91.06 ± 0.45 | 92.51 ± 0.65 | 94.58 ± 0.72 | 85.2 ± 1.03 | NA |
| Sebum (SRI | | | | | | |
| values) | | | | | | |

The data in Table 1 shows that the composition according to the present invention having claimed amounts of alkoxylated anionic surfactant (Ex1, Ex2, Ex3) provides a liquid cleaning composition with an acidic pH (3.2 to 3.5) and desired viscosity, the compositions have improved stain cleaning benefits on oily and sebaceous stains. The compositions outside the present invention (Comp A, Comp B) have inferior stain removal benefits and Comp B does not provide desirable stable foam.

### Example 2: Effect of Non-Ionic Surfactant

Liquid cleaning compositions were prepared based on the recipes shown in Table 2. Composition 4 to 6 are examples of composition according to the present invention, which are compared with comparative compositions C and D, which are not according to the invention. The viscosities of the compositions were determined. In addition, the compositions were sprayed from the spray bottle and the density and quality of the foamed composition were determined. In addition, the compositions were sprayed onto the stained fabric and the pre-treated fabric was washed after this treatment following the procedure described herein before. The results are summarized in Table 2.

TABLE 2
Effect of non-ionic surfactant

| | Marketed | | | | | |
|---|---|---|---|---|---|---|
| | sample | | | | Comp | Comp |
| Ingredient | (Control) | Ex-4 | Ex-5 | Ex-6 | C | D |
| SLES | | 4 | 4 | 4 | 4 | 4 |
| C12EO7 | | 2 | 7.5 | 18 | 1.5 | 26 |
| CAPB | | 0.9 | 0.9 | 0.9 | 0.9 | 0.9 |
| Di(propyleneglycol) | | 6 | 6 | 6 | 6 | 6 |
| dimethyl ether | | | | | | |
| Dequest 2010 | | 1 | 1 | 1 | 1 | 1 |
| Citric acid | | 0.12 | 0.12 | 0.12 | 0.12 | 0.12 |
| Na-citrate | | 0.38 | 0.38 | 0.38 | 0.38 | 0.38 |
| Water | | Rest to | Rest to | Rest to | Rest to | Rest to |
| | | 100 | 100 | 100 | 100 | 100 |
| Viscosity | | 13 | 16 | 49 | 12 | >100 |
| Foam Density | | <0.4 | <0.4 | <0.4 | <0.4 | NA |
| Foamability | | Yes | Yes | Yes | Yes | NA |
| pH | | 3.2-3.5 | 3.2-3.5 | 3.2-3.5 | 3.2-3.5 | 3.2-3.5 |
| Cleaning of | 86 ± 0.2 | 88.41 ± 0.74 | 91.11 ± 0.44 | 93.36 ± 0.09 | 84.2 ± 0.52 | NA |
| cooking oil (SRI) | | | | | | |
| Cleaning of | 86.7 ± 0.31 | 87.04 ± 0.35 | 90.65 ± 1.06 | 93.24 ± 0.67 | 83.2 ± 0.22 | NA |
| Sebum (SRI) | | | | | | |

The data in Table 2 shows that the composition according to the present invention having claimed amounts of non-ionic surfactant (Ex4, Ex5, Ex6) provides a liquid cleaning composition with an acidic pH (3.2 to 3.5) and desired viscosity, the compositions have improved stain cleaning benefits on oily and sebaceous stains. The compositions outside the present invention (Comp C, Comp D) have inferior stain removal benefits and Comp D does not provide desirable stable foam.

### Example 3: Effect of Amphoteric Surfactant

Liquid cleaning compositions were prepared on the basis of the recipes shown in Table 3. Composition 7 to 9 are examples of composition according to the present invention, which are compared with comparative compositions A and B which are not according to the invention. The viscosities of the compositions were determined. In addition, the compositions were sprayed from the spray bottle and the density and quality of the foamed composition were determined. In addition, the compositions were sprayed onto the stained fabric and the pre-treated fabric was washed after this treatment following the procedure described herein before. The results are summarized in Table 3.

TABLE 3
Effect of amphoteric surfactant

| | Marketed | | | | | |
|---|---|---|---|---|---|---|
| | sample | | | | | |
| Ingredient | (control) | Ex-7 | Ex-8 | Ex-9 | Comp E | Comp F |
| SLES | | 4 | 4 | 4 | 4 | 4 |
| C12EO7 | | 7.5 | 7.5 | 7.5 | 7.5 | 7.5 |
| CAPB | | 0.1 | 0.9 | 3 | 0 | 3.5 |
| Di(propyleneglycol) | | 6 | 6 | 6 | 6 | 6 |
| dimethyl ether | | | | | | |
| Dequest 2010 | | 1 | 1 | 1 | 1 | 1 |
| Citric acid | | 0.12 | 0.12 | 0.12 | 0.12 | 0.12 |
| Na-citrate | | 0.38 | 0.38 | 0.38 | 0.38 | 0.38 |
| Water | | Rest to | Rest to | Rest to | Rest to | Rest to |
| | | 100 | 100 | 100 | 100 | 100 |
| Viscosity | | 12 | 16 | 75 | 10 | >100 |
| Foam Density | | <0.4 | <0.4 | <0.4 | <0.4 | NA |
| Foamability | | Yes | Yes | Yes | Yes | NA |
| pH | | 3.2-3.5 | 3.2-3.5 | 3.2-3.5 | 3.2-3.5 | 3.2-3.5 |
| Cleaning of cooking | 86 ± 0.2 | 89.19 ± 0.15 | 91.08 ± 0.13 | 91.19 ± 0.39 | 87.2 ± 0.19 | NA |
| oil (SRI values) | | | | | | |
| Cleaning of Sebum | 86.7 ± 0.31 | 90.08 ± 1.21 | 91.36 ± 0.03 | 91.77 ± 0.63 | 87.3 ± 0.42 | NA |
| (SRI values) | | | | | | |

The data in Table 3 shows that the composition according to the present invention having claimed amounts of amphoteric surfactant (Ex7, Ex8, Ex9) provides a liquid cleaning composition with an acidic pH (3.2 to 3.5) and desired viscosity, the compositions have improved stain cleaning benefits on oily and sebaceous stains. The compositions outside the present invention (Comp E, Comp F) have inferior stain removal benefits and Comp F does not provide desirable stable foam.

### Example 4: Effect of Water Miscible Solvent

Liquid cleaning compositions were prepared based on the recipes shown in Table 4. Composition 10, 11 are examples of composition according to the present invention, which are compared with comparative compositions G and H which are not according to the invention. The viscosities of the compositions were determined. In addition, the compositions were sprayed from the spray bottle and the density and quality of the foamed composition were determined. In addition, the compositions were sprayed onto the stained fabric and the pre-treated fabric was washed after this treatment following the procedure described herein before. The results are summarized in Table 4.

TABLE 4
Effect of solvent

| | Marketed | | | | |
|---|---|---|---|---|---|
| | sample | Comp | | | Comp |
| Ingredient | (control) | G | Ex-10 | Ex-11 | H |
| SLES | | 4 | 4 | 4 | 4 |
| Di(propyleneglycol)dimethyl | | 2 | 15 | 40 | 55 |
| ether | | | | | |
| C12EO7 | | 7.5 | 7.5 | 7.5 | 7.5 |
| CAPB | | 0.9 | 0.9 | 0.9 | 0.9 |
| Dequest 2010 | | 1 | 1 | 1 | 1 |
| Citric acid | | 0.12 | 0.12 | 0.12 | 0.12 |
| Na-citrate | | 0.38 | 0.38 | 0.38 | 0.38 |
| Water | | 86 | 77 | 47 | 32 |
| Viscosity | | 15 | 19 | 19 | 19 |
| Foam Density | | <0.4 | <0.4 | <0.4 | >0.4 |
| Foamability | | Yes | Yes | Yes | Nil |
| pH | | 3.2-3.5 | 3.2-3.5 | 3.2-3.5 | 3.2-3.5 |
| Cleaning of Sebum (SRI) | 86 ± 0.2 | 85.69 ± 0.15 | 91.23 ± 0.22 | 90.76 ± 0.1 | NA |
| Cleaning of cooking oil (SRI | 86.7 ± 0.31 | 85.14 ± 0.21 | 90.53 ± 0.18 | 91.34 ± 0.21 | NA |
| values) | | | | | |

The data in Table 4 shows that the composition according to the present invention having claimed amounts of water miscible solvent (Ex10, Ex11) provides a liquid cleaning composition with an acidic pH (3.2 to 3.5) and desired viscosity, the compositions have improved stain cleaning benefits on oily and sebaceous stains. The compositions outside the present invention (Comp G, Comp H) have inferior stain removal benefits and Comp H does not provide desirable foaming which has a liquid consistency with big bubbles and does not form a stable foam.

### Example 5: Effect of Ratio of Sum of Anionic Surfactant and Non-Ionic Surfactant to Solvent

Liquid cleaning compositions were prepared based on the recipes shown in Table 5. Composition 12 to 14 are examples of composition according to the present invention, which are compared with comparative compositions I and J which are not according to the invention. The viscosities of the compositions were determined. In addition, the compositions were sprayed from the spray bottle and the density and quality of the foamed composition were determined. The results are summarized in Table 5.

TABLE 5
Effect of ratio of surfactant to solvent

| | Comp | | | | Comp |
|---|---|---|---|---|---|
| Ingredient | I | Ex-12 | Ex-13 | Ex-14 | J |
| SLES | 2 | 8 | 12 | 16 | 18 |
| Di(propyleneglycol)dimethyl | 20 | 20 | 10 | 3 | 4 |
| ether | | | | | |
| C12EO7 | 2 | 2 | 8 | 8 | 22 |
| Sum total of | 4 | 10 | 20 | 24 | 30 |
| anionic surfactant | | | | | |
| and non-ionic) | | | | | |
| Total surfactant to | 0.2:1 | 0.5:1 | 2:1 | 8:1 | 10:1 |
| solvent ratio | | | | | |
| CAPB | 0.9 | 0.9 | 0.9 | 0.9 | 0.9 |
| Dequest 2010 | 1 | 1 | 1 | 1 | 1 |
| Citric acid | 0.12 | 0.12 | 0.12 | 0.12 | 0.12 |
| Na-citrate | 0.38 | 0.38 | 0.38 | 0.38 | 0.38 |
| Water | Rest to | Rest to | Rest to | Rest to | Rest to |
| | 100 | 100 | 100 | 100 | 100 |
| Viscosity | 15 | 20 | 45 | 19 | >100 |
| Foam Density | >0.4 | <0.4 | <0.4 | <0.4 | NA |
| Foamability | Nil | Yes | Yes | Yes | Nil |
| pH | 3.2-3.5 | 3.2-3.5 | 3.2-3.5 | 3.2-3.5 | 3.2-3.5 |

The data in Table 5 shows that the composition according to the present invention having claimed ratio of sum of alkoxylated anionic surfactant and nonionic surfactant to the solvent (Ex12, Ex13, Ex14) provides a liquid cleaning composition with an acidic pH (3.2 to 3.5) and has desired viscosity, the compositions have improved creamy thick stable foam. The compositions outside the present invention (Comp I, Comp J) have inferior foam characteristics, both of them forms bubbles with high liquid content which is not stable and does not have the desired foam characteristics.

### Example 6: Effect of PH

Liquid cleaning compositions were prepared based on the recipes shown in Table 6. Composition 15 is an example of composition according to the present invention, which is compared with comparative compositions K and L which are outside the scope of the invention. The compositions were sprayed onto the stained fabric and the pre-treated fabric was washed after this treatment following the procedure described herein before. The results are summarized in Table 6.

TABLE 6
Compositions at different pH conditions

| Ingredient | Ex-15 | Comp K | Comp L |
|---|---|---|---|
| SLES | 4 | 4 | 4 |
| Di(propyleneglycol) | 15 | 15 | 15 |
| dimethyl ether | | | |
| C12EO7 | 7.5 | 7.5 | 7.5 |
| CAPB | 0.9 | 0.9 | 0.9 |
| Dequest 2010 | 1 | 1 | 1 |
| Citric acid | 0.12 | 0 | 0 |
| Na-citrate | 0.38 | 3 | 0 |
| NaOH | — | — | 1 |
| Water | Rest to 100 | Rest to 100 | Rest to 100 |
| pH of the composition | 2.5 | 5 | 8 |
| Cleaning of cooking oil | 91.23 ± 0.22 | 84.90 ± 0.20 | 84.20 ± 0.30 |
| (SRI values) | | | |
| Cleaning of sebum (SRI | 90.53 ± 0.18 | 85.70 ± 0.10 | 85.11 ± 0.11 |
| values) | | | |

The data in Table 6 shows that the composition according to the present invention having claimed pH values (Ex15) provides a liquid cleaning composition with improved stain removal benefits as compared to the comparative composition (Comp L) having alkaline pH values.

### Example 6: Effect of Hydrogen Peroxide

Liquid cleaning compositions were prepared on the basis of the recipes shown in Table 7. Composition 16 and 17 is an example of composition according to the present invention. The compositions were sprayed onto the stained fabric and the pre-treated fabric was washed after this treatment following the procedure described herein before. The results are summarized in Table 7.

TABLE 7
Compositions with and without hydrogen peroxide

| | Marketed | | |
|---|---|---|---|
| | sample | | |
| Ingredient | (Control) | Ex-16 | Ex-17 |
| SLES | | 4 | 4 |
| C12EO7 | | 7.5 | 7.5 |
| CAPB | | 0.9 | 0.9 |
| Di(propyleneglycol)dimethyl | | 6 | 6 |
| ether | | | |
| H₂O₂ | | 0 | 4 |
| Dequest 2010 | | 1 | 1 |
| Citric acid | | 0.12 | 0.12 |
| Na-citrate | | 0.38 | 0.38 |
| Water | | Rest | Rest |
| Viscosity | | 16 | 14 |
| Foam Density | | <0.4 | <0.4 |
| Foamability | | Yes | Yes |
| pH | | 3.2-3.5 | 3.2-3.5 |
| Cleaning of cooking | 86 ± 0.2 | 92.68 ± 0.37 | 95.68 ± 0.21 |
| oil (SRI values) | | | |
| Cleaning of Sebum | 86.7 ± 0.31 | 92.51 ± 0.65 | 93.8 ± 0.11 |
| (SRI values) | | | |

The data in Table 7 shows that the composition according to the present invention further having hydrogen peroxide (Ex17) provides a liquid cleaning composition with an acidic pH (3.2 to 3.5) and has desired viscosity, the compositions have improved creamy thick stable foam and gives further improved stain removal benefits on cooking oil and sebum stains when compared to a composition (Ex 16) according to the present invention but without the addition of hydrogen peroxide.

It will be appreciated that the illustrated examples provide a foamable liquid having a foamable, liquid cleaning composition comprising 1 to 20 wt. % C₈₋₁₈ alkoxylated anionic surfactant having 1 to 30 moles of alkylene oxide; 2 to 25 wt. % nonionic surfactant; 0.1 to 3 wt. % of amphoteric surfactant; 3 to 40 wt. % a water miscible solvent; and, rest water and the cleaning composition having a viscosity of less than 100 mPa·s at 25° C. and 20 s-1, wherein the ratio of the sum of alkoxylated surfactant and nonionic surfactant to the solvent is in a weight ratio of 0.3:1 to 9:1 and wherein the pH of the composition measured at less than 5.

It should be understood that the specific forms of the invention herein illustrated and described are intended to be representative only as certain changes may be made therein without departing from the clear teachings of the disclosure.

Although the invention has been described with reference to specific embodiments, it will be appreciated by those skilled in the art that the invention may be embodied in many other forms.

1. A foamable, liquid cleaning composition comprising:
a. 1 to 20 wt. % C₈₋₁₈ alkoxylated anionic surfactant having 1 to 30 moles of alkylene oxide;
b. 2 to 25 wt. % nonionic surfactant;
c. 0.1 to 3 wt. % amphoteric surfactant;
d. 3 to 40 wt. % water miscible solvent; and,
e. rest water
said cleaning composition having a viscosity of less than 100 mPa·s at 25° C. and 20 s-1, wherein the ratio of the sum of alkoxylated anionic surfactant and nonionic surfactant to the solvent is in a weight ratio of 0.3:1 to 9:1 and wherein the pH of the composition is less than 4.

2. The composition according to claim 1 wherein the pH is from 2 to 3.5.

3. The composition according to claim 1 wherein the amount of water miscible solvent is from 1 to 40 wt % of the foamable liquid cleaning composition.

4. The composition according to claim 1 wherein the water miscible solvent has a Hansen solubility parameter of from 14 to 22 M/Pa^{0.5} (at 25° C.).

5. The composition according to claim 1 wherein the solvent is a glycol ether solvent with flash point more than 80° C., more preferably more than 100° C., most preferably above 115° C.

6. The composition according to claim 1, wherein the C₈₋₁₈ alkoxylated anionic surfactant preferably has 1 to 20 moles of ethylene oxide, more preferably 1 to 10 moles of ethylene oxide.

7. The composition according to claim 1, wherein the amphoteric surfactant is selected from amine oxide, betaine and combinations thereof.

8. The composition according to claim 1, wherein the non-ionic surfactant is selected from an alkoxylated linear alcohol, more preferably an ethoxylated linear alcohol.

9. The composition according to claim 1, wherein the cleaning composition contains at least 12 wt. %, more preferably 30 to 90 wt. %, most preferably 40 to 80 wt. % of water.

10. The composition according to claim 1, comprises at least 2 wt. %, preferably 3 to 12 wt. % of hydrogen peroxide.

11. The composition according to claim 1 wherein the composition comprises a buffering agent.

12. A cleaning system comprising a spraying device and a foamable liquid cleaning composition according to claim 1, said spraying device comprising a container holding the foamable liquid cleaning composition, a spray head, and a liquid supply arrangement for transferring the foamable liquid detergent composition from the container to the spray head and forming a foam with a density of less than 0.4 g/ml when ejected from the spray device through the spray head.

13. A cleaning system according to claim 12, wherein the spraying device is selected from a trigger spray foam bottle, a squeeze foam bottle and a foam pump.

14. A method of removing oily fatty stains from fabric, said method comprising the steps of:
a. providing a fabric;
b. pre-treating the fabric by applying a foamable liquid cleaning composition according to any of the preceding claims 1 to 13 as a foam onto the surface of the fabric;
c. washing the pre-treated fabric; and,
d. drying the washed fabric.

15. (canceled)
